(19) United States
(12) Patent Application Publication
(10) Pub. No.: US 2009/0318609 A1
(43) Pub. Date: Dec. 24, 2009

(54) Method for producing a nitrogen functionalised surface

(76) Inventors: Jas Pal Singh Badyal, County Durham (GB); Declan Oliver Hastings Teare, Old Elvet (GB); Wayne Christopher Edward Schofield, Chester (GB)

Correspondence Address: CLARK & ELBING LLP, 101 FEDERAL STREET, BOSTON, MA, 02110, US

(21) Appl. No.: 11/918,580

(22) PCT Filed: Apr. 11, 2006
(86) PCT No.: PCT/GB2006/001331

§ 371 Date: Jun. 19, 2009

(30) Foreign Application Priority Data
Apr. 18, 2005 (GB) 0507753.2

(51) Int. Cl. C08L 39/08; B05D 1/00

(52) U.S. Cl. 524/548; 427/569

(57) ABSTRACT

A method is provided for applying a coating containing reactive nitrogen functionality contained within an aromatic heterocyclic structure to a substrate. The method includes subjecting said substrate to a plasma discharge of a monomer possessing said heterocyclic nitrogen functionality.

The present invention relates to the production of coatings that possess a reactive nitrogen functionality contained within an aromatic heterocyclic structure, using the plasma polymerisation of compounds such as 4-vinyl pyridine. Such surfaces may be super-hydrophilic and can be subject to subsequent derivatization or quarternization with other functional groups, such as haloalkanes.

The surface functionalisation of solid objects is a topic of considerable technological importance, since it offers a cost effective means for improving substrate performance without affecting the overall bulk properties.

Compounds that possess usable nitrogen functionality within an aromatic heterocyclic ring have a wide range of properties and applications (Organic Chemistry, J. McMurry, 3^{rd} edition, Chapter 29). Their characteristics are dependent on the particular heterocyclic under investigation and include varying degrees of basicity, nucleophilicity, and amenability to a range of derivatization reactions that include electrophilic substitution, nucleophilic aromatic substitution and quaternization.

In addition to their fundamental reactivity, nitrogen-containing aromatic heterocyclic compounds often exhibit pronounced biological activity. Molecules such as quinine (an anti-malarial drug) and N,N dimethyltryptamine (a hallucinogenic drug) are both important examples of naturally occurring fused-ring nitrogen containing heterocycles, the former being a quinoline derivative (possessing a benzene ring fused to pyridine) and the latter being an indole alkaloid (possessing a benzene ring fused to pyrrole). Two other important classes of aromatic nitrogenous heterocycles are the pyrimidines and purines, derivatives of which include the nitrogenous bases found within the structures of DNA and RNA (i.e. adenine, guanine, cytosine, thymine and uracil).

It should hence be evident to those skilled in the art that a means of attaching such functionalities to almost any substrate surface would be of use in a variety of applications (sensors, drug discovery etc).

Of particular utility are coatings bearing functionality derived from pyridine. Amongst their many uses, the presence of pyridine groups at the surface can provide sites for the generation of quaternary ammonium salts that have antibacterial properties (Tan, S. et al., J. Appl. Polym. Sci. 2000, 77, 1861; Tan, S. et al., J. Appl. Polym. Sci. 2000, 77, 1869; Li, G. et, al. J. Appl Polym. Sci 2000, 78, 676; Li, G. et. al. J. Appl. Polym. Sci. 2000, 78, 668). It has been previously shown that pyridinium-type quarternary ammonium salt resins are popular candidates for use as disinfectants due to their broad spectrum of antibacterial activity, high kill rate, and their non-toxicity towards mammalian cells (Tan, S. et. al., J. Appl. Polym. Sci. 2000, 77, 1861; Tan, S. et al, J. Appl Polym. Sci 2000, 77, 1869; Li, G. et al. J. Appl. Polym. Sci. 2000, 78, 676; Li, G. et. al. J. Appl. Polym. SCi. 2000, 78, 668). The bactericidal ability of these compounds has been attributed to the penetration of their surface-attached polycationic chains into the bacterial membrane, resulting in cell damage and death (Tiller, J. C. et al., Biotechnol. Bioeng. 2002, 79, 465; Tiller, J. C. et al., PNAS 2001, 98, 5981; Lin, J. et al., Biotechnol. Lett. 2002, 24, 801). A means of producing pyridine-type polymer coatings would hence have great utility in the active antimicrobial fight against the spread of bacteria such as Staphylococcus aureus, Streptococcus pneumoniae, Escheria coli (E. coli), salmonella, nosocomial and community-acquired pathogens (e.g. methicillin-resistant Staphylococcus aureus (MRSA) and methicillin-resistant Staphylococcus epidermis (MRSE)) that commonly colonize on hospital staff and patients. Staphylococcus aureus is frequently implicated in wound infections, osteomyelitis, endocarditis, and sepsis (Leder, K. et al., Antimocrob. Chemother. 1999, 43, 113).

Additional applications of pyridine containing coatings, including those produced by this invention, are in cell adhesion and growth; a consequence of their combination of super-hydrophilicity and insolubility. The adhesion and growth of cells on a surface is considered to be strongly influenced by the balance of hydrophilicity/hydrophobicity, frequently described as wettability (Horbett, T. A.; et al. J. Biomed. Mater. Res. 1988, 22, 763; Chin, J. A. et. al. J. Colloid Interface Sci. 1989, 127, 67; Ertel, S. I. et al. J. Biomed. Mater. Res. 1990, 24, 1637). Hydrophilic polymers have been shown to promote cell attachment and growth without the need for protein pre-coating (Marchant, K. K. et. al. J. Biomed. Mater. Res. 1996, 30, 209; Marugesan, G. et. al. J. Biomed. Mater. Res. 2000, 49, 396; Burridge, K. et. al. Ann. Rev. Cell. Dev. Biol. 1996,12, 463). Cells of particular interest include, but are not restricted to, human epithelial cells that have shown enhanced attachment and growth.

Yet another application of pyridine containing coatings is in the electroless deposition of metals that include elemental nickel, copper, aluminium, silver, and gold. The controlled deposition of metals onto a variety of substrates has a multitude of uses including the manufacture of printed circuit boards, porous electrodes and other electronic devices, and the metallization of cloth, decorative coatings, gas barrier layers, and gas sensors. In the electroless process an aqueous chemical reducing agent is used to heterogeneously reduce metal ions to their elemental oxidation state. The reaction mechanism is seeded by an initiator or catalyst such as palladium, although other noble metals including gold and silver may be used. However, palladium cannot be chemisorbed onto inert substrates; it has to be attached to surface-bound chemical species containing accessible nitrogen groups. Pyridine containing films can provide these nitrogen groups and hence enable the electroless deposition of metals onto a variety of surfaces.

Existing methods of attaching nitrogen containing aromatic heterocyclic rings to solid surfaces have hence often focussed upon the production of pyridine functionalised coatings. Methods employed in the past have included: electron beam irradiation with 4-vinyl pyridine grafting (Lee, W. et al., Colloid Interface Sci. 1998, 200, 66), UV irradiation of substrates immersed in a solution containing a polymerisable pyridine monomer (e.g. 4-vinyl pyridine) and an initiator (Lee, W. et. al. J. Colloid Interface Sci. 1998, 200, 66), and plasma surface activation followed by conventional solution phase grafting (Tan, S. et al., J. Appl. Polym. Sci 2000, 77, 1861; Tiller, J. C. et al. Proc. Natl. Acad. Sci. USA 2001, 98, 5981; Krishnan, S. et. al. Polym. Mater.: Sci. Eng. 2004, 91, 814). All of these approaches suffer from drawbacks such as involving multi-step processes, substrate specificity, and the requirement for solution phase chemistry.

In addition to these methods, surfaces bearing nitrogen containing aromatic heterocyclic rings have been prepared by plasma polymerisation. The plasma deposition of monomers including pyrrole, pyridine and quinoline has been reported previously (Hou, Z-k. et al, Gaofenzl Calilao Kexue Yu Gongcheng, 2001, 17(1), 51; Xie , X. et al, Thin Solid Films, 1996, 278(1-2), 118; Ebert, E. and Weisweiler, W., Applied Sciences, 1993, 230, 287). However, in each case the retention of monomer structure was poor and the coated surfaces exhibited low levels of residual aromaticity and little usable nitrogen containing functionality. The observed inadequate levels of sample performance were largely due to the nature of the monomers utilised. Underivatized nitrogen containing aromatic heterocyclic rings lack an additional functional group, separate from the ring(s) (for example, a pendent acrylate or alkene moiety), that can be readily polymerised by conventional reaction pathways. Hence, the deposition of such monomers must proceed via their aromatic heterocyclic functionality, resulting in unavoidable rupture of the monomer structure and impairment or alteration of the desired nitrogen functionality contained within. In the prior art cited above, this undesirable situation was also exacerbated by the harsh, high power, continuous-wave conditions plasma polymerisation was performed under. The heavily cross-linked nature and poor surface properties of the resulting coatings was hence the inevitable consequence of a doubly flawed methodology.

However, the plasma polymerisation of monomers possessing a polymerisable group distinct from the nitrogen containing ring functionality has been attempted in the past using 4-vinyl pyridine. Nonetheless, the results were again disappointing, the resulting surfaces were heavily cross-linked, prone to oxidative aging (due to high concentrations of trapped radicals) and exhibited unpredictable chemical natures (Ellaboudy, A. S. et al, Journal of Applied Polymer Science, 1996, 60(4), 637; Dominguez, M. E. et al, Analytical Letters, 1995, 28(6), 945). These poor results could be ascribed to the high-power, continuous wave plasma polymerisation methodology employed. A fundamental reason why plasma polymers are often structurally inconsistent compared to their conventional counterparts (with high levels of cross-linking and no regular repeat unit) is that the plasma environment generates a whole range of reactive intermediates that contribute to an overall lack of chemical selectivity (Yasuda, H. Plasma Polymerisation Academic Press: New York, 1985). However, it has been found that pulsing electric discharges on the ms-μs timescale can significantly improve structural retention of the parent monomer species (Panchalingam, V. et al., Appl. Polym. Sci. 1994, 54, 123; Han, L. M. et al., Chem. Mater., 1998, 10, 1422; Timmons et al., U.S. Pat. No. 5,876,753) and in some cases conventional linear polymers have been synthesised (Han, L. M. et al., J. Polym. Sci., Part A: Polym. Chem. 1998, 36, 3121). Under such conditions, repetitive short bursts of plasma are understood to control the number and lifetime of active species created during the on-period, which then is followed by conventional reaction pathways (e.g. polymerisation) occurring during the off-period (Ryan, M. E. et al., Chem. Mater., 1996, 8, 37).

The applicants have found that low average-power continuous wave or pulsed plasma polymerisation can potentially overcome the limitations of existing techniques for the production of surfaces bearing nitrogen containing aromatic heterocyclic moieties.

According to a first aspect of the present invention there is provided a method for applying a coating containing reactive nitrogen functionality contained within an aromatic heterocyclic structure to a substrate, said method including subjecting said substrate to a plasma discharge of a monomer possessing said heterocyclic nitrogen functionality.

The method of the invention preferably utilises a low average-power substantially continuous wave or pulsed plasma deposition procedure.

The method of the invention preferably utilises monomers possessing at least one conventionally polymerisable unsaturated functional group (e.g. selected from acrylate, methacrylate, alkene, styrene, alkyne and/or derivatives thereof) that is substantially distinct from the nitrogen containing aromatic ring structure desired at the substrate surface (e.g. selected from pyridine, pyrrole, quinoline, isoquiniline, purine, pyrimidine, indole and/or derivatives thereof).

In especially preferred embodiments, the method of the invention uses a pulsed plasma polymerisation procedure applied to a monomer possessing at least one conventionally polymerisable, unsaturated functional group (e.g. selected from acrylate, methacrylate, alkene, styrene and/or alkyne) that is substantially distinct from the nitrogen containing aromatic ring structure desired at the substrate surface (e.g. selected from pyridine, pyrrole, quinoline, isoquiniline, purine, pyrimidine, and/or indole). In such preferred embodiments of the invention, plasma polymerisation of the monomer substantially occurs via the conventionally polymerisable, unsaturated functional group (e.g. acrylate, methacrylate, alkene, styrene, alkyne) by conventional mechanisms during the plasma off-time, without damage or interference to the separate, desired, nitrogenous heterocyclic functionality.

According to the present invention there is provided a method for applying a reactive coating possessing nitrogen containing aromatic heterocyclic structures to a substrate, said method comprising subjecting said substrate to a plasma discharge in the presence of a compound possessing said nitrogen containing aromatic heterocyclic functionality. Suitable compounds for use in the invention including, but not being limited to, derivatives of pyridine, pyrrole, quinoline, isoquiniline, purine, pyrimidine and indole. In a preferred aspect of the invention, the plasma discharge is pulsed so as to produce a coating substantially retaining the structure of the original monomer. In another preferred aspect of the invention, the monomer possesses, in addition to the desired heterocyclic moiety, at least one conventionally polymerisable unsaturated functional group (e.g. acrylate, methacrylate, alkene, styrene, alkyne) that can be polymerised without substantially deleterious effect to the desired nitrogen functionality. In an especially preferred aspect of the invention, the method utilises both a pulsed plasma deposition technique and a monomer that possesses said conventionally polymerisable unsaturated functional group(s) in addition to the desired heterocyclic moiety.

In particularly preferred embodiments of the present invention the method comprises subjecting the substrate to a plasma discharge in the presence of a pyridine derivative of formula (I) or formula (Ia):

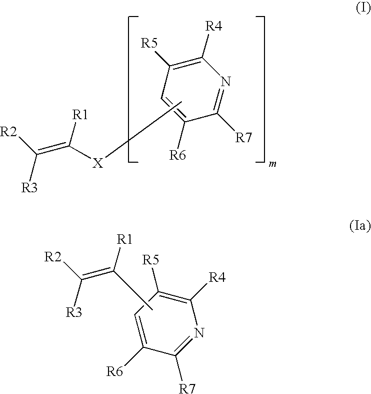

Where X is an optionally substituted straight or branched alkylene chain(s) or aryl group(s); R¹, R², R³, R⁴, R⁵, R⁶ or R⁷ are hydrogen or optionally substituted hydrocarbyl or heterocyclic groups; and m is an integer greater than 0. The pyridine group, which itself may be optionally substituted, may be attached to the polymerisable moiety via ortho, meta or para substitution.

As used herein, the term “hydrocarbyl” Includes alkyl, alkenyl, alkynyl, aryl and aralkyl groups. The term “aryl” refers to aromatic cyclic groups such as phenyl or naphthyl, in particular phenyl. The term “alkyl” refers to straight or branched chains of carbon atoms, suitably of from 1 to 20 carbon atoms in length. The terms “alkenyl” and “alkynyl” refer to straight or branched unsaturated chains suitably having from 2 to 20 carbon atoms. These groups may have one or more multiple bonds. Thus examples of alkenyl groups include allenyl and dienyl.

Suitable optional substituents for hydrocarbyl groups R¹, R², R³, R⁴, R⁵, R⁶ or R⁷, and alkylene/aryl groups X are groups that are substantially inert during the process of the invention. They may include halo groups such as fluoro, chloro, bromo and iodo. Particularly preferred halo substituents are fluoro.

In a particularly preferred embodiment of the invention with reference to formula (Ia), the pyridine group is unsubstituted (i.e. R⁴, R⁵, R⁶, and R⁷ are all hydrogen groups) and R¹, R², and R³ are independently selected from hydrogen or alkyl, and in particular, from hydrogen or a C₁₋₆ alkyl, such as methyl. Thus, in a particularly preferred embodiment, the compound of formula (Ia) is a compound of formula (Iai)

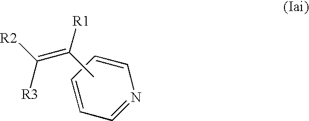

A particular example of a compound of formula (Iai) is 4-vinyl pyridine. In this compound R¹, R², and R³ are all hydrogen atoms and the resultant vinyl moiety is attached to the pyridine ring at the para position:

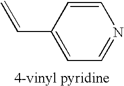

In an alternative preferred embodiment of the invention with reference to formula (I), aside from the requisite polymerisable functionality, the pyridine group is unsubstituted (i.e. R⁴, R⁵, R⁶, and R⁷ are all hydrogen groups) and X is a moiety comprising an ester group adjacent to an optionally substituted hydrocarbyl or heterocyclic group, RF and m is an integer greater than zero. Thus, in a particular embodiment, the compound of formula (I) is a compound of formula (II):

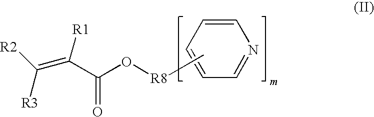

In particular, R¹, R², R³ and R⁸ are independently selected from hydrogen or alkyl, and in particular, from hydrogen or C₁₋₆ alkyl, such as methyl. Thus, in a particularly preferred embodiment, the compound of formula (II) is a compound of formula (III): the desired pyridine functionality is connected to a readily polymerised acrylate group (CH₂═CH—CO₂—) via a saturated alkyl hydrocarbon chain linker, R⁸, where n is an integer of from 1 to 20 and m is an integer greater than zero:

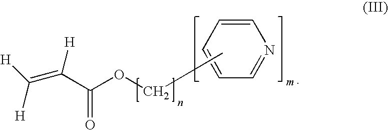

A particular example of a compound of formula (III), where m=1 and n=1, is 4-ethyl acrylate pyridine.

In another particularly preferred embodiment, the compound of formula (II) is a compound of formula (IIIa): the desired pyridine functionality is connected to a readily polymerised methacrylate group (CH₂═C(CH₃)—CO₂—) via a saturated alkyl hydrocarbon chain linker, R⁸, where n is an integer of from 1 to 20 and m is an integer greater than zero:

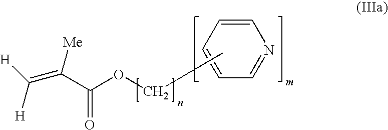

A particular example of a compound of formula (IIIa), where m=1 and where n=1, is 4-ethyl methacrylate pyridine.

In other particularly preferred embodiments of the invention, with reference to the compound of formula (I), R¹, R² and R³ are again independently selected from hydrogen or alkyl, and in particular, from hydrogen or C₁₋₆ alkyl, such as methyl, and aside from the readily polymerisable moiety, the pyridine group is unsubstituted (i.e. R⁴, R⁵, R⁶, and R⁷ are all hydrogen groups). Thus, in another particular embodiment, the compound of formula (I) is a compound of formula (IV):

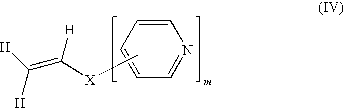

where X is as defined above and m is an integer greater than 0.

Particularly preferred compounds of formula (IV) are those where X is a saturated alkyl hydrocarbon chain. Thus, the compound of formula (IV) is a compound of formula (V) where n is an integer of from 1 to 20 and m is an integer greater than zero. For example from n=1 to 10 and preferably 8.

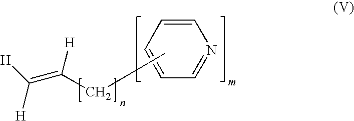

Precise conditions under which plasma deposition of the nitrogen containing aromatic heterocyclic monomer takes place in an effective manner will vary depending upon factors such as the nature of the monomer, the substrate, the size and architecture of the plasma deposition chamber etc. and will be determined using routine methods and/or the techniques illustrated hereinafter. In general however, polymerisation is suitably effected using vapours or atomised droplets of the monomer (or monomers) at pressures of from 0.01 to 999 mbar, suitably at about 0.2 mbar. Although atmospheric-pressure and sub-atmospheric pressure plasmas are known and utilised for plasma polymer deposition in the art.

A glow discharge is then ignited by applying a high frequency voltage, for example at 13.56 MHz. The applied fields are suitably of an average power of up to 50 W.

If continuous-wave excitation is used the average power should be as low as possible to maximise retention of the monomer functionality within the product coating. Applied continuous wave powers of the order of 2 W for a 520 cm³ plasma reactor have been found to be most suitable.

The fields are suitably applied for a period sufficient to give the desired coating. In general, this will be from 30 seconds to 60 minutes, preferably from 1 to 15 minutes, depending upon the nature of the nitrogen containing aromatic heterocyclic monomer and the substrate etc.

Most suitably, the discharge is pulsed. The average power of the pulsed plasma discharge is low, for example of less than 0.05 W/cm³, preferably less than 0.025 W/cm³ and most preferably less than 0.0025 W/cm³.

The pulsing regime which will deliver such low average power discharges will vary depending upon the nature of the substrate, the size and nature of the discharge chamber etc. However, suitable pulsing arrangements can be determined by routine methods in any particular case. A typical sequence is one in which the power is on for from 10 ps to 100 μs, and off for from 1000 ps to 20000 μs.

In one embodiment of the invention the pulsing regime is varied during the course of a single coating deposition so as to enable the production of gradated coatings. For example, a high average-power pulsing regime may be used at the start of sample treatment to yield a highly cross-linked, insoluble sub-surface coating that adheres well to the substrate. A low average-power pulsing regime may then be adopted for conclusion of the treatment cycle, yielding a surface layer displaying high levels of retained nitrogen containing aromatic heterocyclic monomer functionality on top of said well-adhered sub-surface. Such a regime would be expected to improve overall coating durability and adhesion, without sacrificing any of the desired surface properties (i.e. reactive surface nitrogen functionality).

Suitable plasmas for use in the method of the invention include non-equilibrium plasmas such as those generated by audio-frequencies, radiofrequencies (RF) or microwave frequencies. In another embodiment the plasma is generated by a hollow cathode device. In yet another embodiment, the pulsed plasma is produced by direct current (DC).

The plasma may operate at low, sub-atmospheric or atmospheric pressures as are known in the art. The monomer and/or any additional material may be introduced into the plasma as a vapour or an atomised spray of liquid droplets (WO03101621 and WO03097245, Surface Innovations Limited). The monomer may be introduced into the pulsed plasma deposition apparatus continuously or in a pulsed manner by way of, for example, a gas pulsing valve.

The substrate to which the pyridine bearing coating is applied will preferentially be located substantially inside the pulsed plasma during coating deposition, However, the substrate may alternatively be located outside of the pulsed plasma, thus avoiding excessive damage to the substrate or growing coating.

The monomer will typically be directly excited within the plasma discharge. However, “remote” plasma deposition methods may be used as are known in the art. In said methods the monomer enters the deposition apparatus substantially “downstream” of the pulsed plasma, thus reducing the potentially harmful effects of bombardment by short-lived, high-energy species such as ions.

The plasma may comprise the heterocyclic nitrogen containing monomeric compound alone, in the absence of other compounds or in admixture with for example an inert gas. Plasmas consisting of monomeric compound alone may be achieved as illustrated hereinafter, by first evacuating the reactor vessel as far as possible, and then purging the reactor vessel with the organic compound for a period sufficient to ensure that the vessel is substantially free of other gases. The temperature in the plasma chamber is suitably high enough to allow sufficient monomer in gaseous phase to enter the plasma chamber. This will depend upon the monomer and conveniently ambient temperature will be employed. However, elevated temperatures for example from 25 to 250° C. may be required in some cases.

In alternative embodiments of the invention, materials additional to the plasma polymer coating precursor are present within the plasma deposition apparatus. The additional materials may be introduced into the coating deposition apparatus continuously or in a pulsed manner by way of, for example, a gas pulsing valve.

Said additive materials may be inert and act as buffers without any of their atomic structure being incorporated into the growing plasma polymer (suitable examples include the noble gases). A buffer of this type may be necessary to maintain a required process pressure. Alternatively the inert buffer may be required to sustain the plasma discharge. For example, the operation of atmospheric pressure glow discharge (APGD) plasmas often requires large quantities of helium. This helium diluent maintains the plasma by means of a Penning Ionisation mechanism without becoming Incorporated within the deposited coating.

In other embodiments of the invention, the additive materials possess the capability to modify and/or be incorporated into the coating forming material and/or the resultant plasma deposited coating. Suitable examples include other reactive gases such as halogens, oxygen, and ammonia.

In alternative embodiments of the invention, the additive materials may be other monomers. The resultant coatings comprise copolymers that contain reactive nitrogen functionality with an aromatic heterocyclic structure. Suitable monomers for use within the method of the invention include organic (e.g. styrene), inorganic, organo-silicon and organo-metallic monomers.

The invention further provides a substrate having a coating possessing nitrogen containing aromatic heterocyclic functionality thereon, obtained by a process as described above. Such substrate can include any solid, particulate, or porous substrate or finished article, consisting of any materials (or combination of materials) as are known in the art. Examples of materials include, but are not limited to, woven or non-woven fibres, natural fibres, synthetic fibres, metal, glass, ceramics, semiconductors, cellulosic materials, paper, wood, or polymers such as polytetrafluoroethylene, polythene or polystyrene. In a particular embodiment, the surface comprises a support material, such as a polymeric material, used in biochemical analysis.

In one embodiment of the invention the substrate is coated continuously by means of a reel-to-reel apparatus. In one embodiment the substrate is moved past and through a coating apparatus acting in accordance with this invention.

The method of the invention may result in a product wholly coated in a polymer coating possessing nitrogen containing aromatic heterocyclic functionality.

In an alternative aspect of the invention the nitrogen containing aromatic heterocycle functionalised polymer coating is only present on selected surface domains of the substrate. The applications of such patterned substrates are multitudinous and include fields where the spatial control of surface wettability is a consideration. Coatings produced according to the method of the invention may hence have utility as the hydrophilic domains of products that include micro-fluidic devices and micro-condensers.

The restriction of the nitrogen containing aromatic heterocycle coating to specific surface domains may be achieved by limiting the means of coating production of the method to said specific surface domains. In one embodiment of this aspect of the invention, the aforementioned spatial restriction is achieved by plasma depositing the coating through a mask or template. This produces a sample exhibiting regions covered with nitrogen containing aromatic heterocycle functionalised coating juxtaposed with regions that exhibit no nitrogen containing aromatic heterocycle functionalised coating.

An alternative means of restricting the properties associated with the nitrogen containing aromatic heterocycle functionalised polymer coating to specific surface domains comprises: depositing the nitrogen containing aromatic heterocycle functionalised polymer over the entire surface of the sample or article, then rendering selected areas of it substantially deficient of the properties associated with the nitrogen containing aromatic heterocycle. The spatially selective removal/damage of the nitrogen containing aromatic heterocycle functionalised polymer may be achieved using numerous means as are described in the art. Suitable methods include, but are not limited to, electron beam etching and exposure to ultraviolet irradiation through a mask. The pattern of non-transmitting material possessed by the mask is hence transferred to areas of functionalisation with the nitrogen containing aromatic heterocycle.

The plasma polymerisation method of the invention is therefore a solventless method for functionalising solid surface with nitrogen containing aromatic heterocyclic groups. In a preferred embodiment of the invention said heterocyclic groups are derived from pyridine. In a further aspect of the method the pyridine functionalised monomer is a compound of formula (I) or (Ia) deposited by a pulsed plasma polymerisation method.

The nitrogen containing aromatic heterocyclic group containing coating may be utilised without further modification or derivatization. Suitable applications for such coatings include, but are not restricted to, uses that necessitate a high degree of wettability (i.e super-hydrophilicity) such as micro-condenser manufacture and cell growth and attachment, and uses that require reactive nitrogen functionality, such as electroless metal deposition.

In alternative embodiments of the invention, once the functional coating has been applied to the substrate, the nitrogen containing aromatic heterocyclic group may be further derivatised, reacted, quarternized or complexed as required. In especially preferred embodiments of the invention, the coating is produced from a pyridine functionalised monomer of formula (I) or (Ia). In further embodiments of the invention the coating is quarternized by a haloalkane such as, but not limited to bromobutane. The derivatization, quarternization, reaction or complexation may be effected in the gaseous phase where the reagents allow, or in a solvent such as water or an organic solvent. Examples of such solvents include alcohols (such as methanol), and tetrahydrofuran. For example, a solution of said haloalkene is contacted with the surface under conditions in which the haloalkene functionality reacts with the nitrogen functionality contained within the aromatic heterocyclic structures on the surface.

Preferably the quaternized surfaces of the substrate possess antibacterial properties. The antibacterial properties can be regenerated by washing in water or aqueous solution.

According to one aspect of the present invention there is provided a method for the quarternization of an aromatic heterocyclic functionalised reagent at a surface, said method including the application of a reactive heterocyclic nitrogen functionalised coating to said surface, and then contacting the surface with a solution of said haloalkane-containing agent under conditions such that the haloalkane group reacts with the reactive nitrogen functionalities contained within the aromatic heterocyclic structures on the substrate surface.

In a further embodiment, the invention provides a method for the immobilisation of metal containing agents, including initiators and catalysts, on surfaces. Said method comprises the application of a reactive, nitrogen containing aromatic heterocycle functionalised coating to a surface by a plasma deposition method described above, and then contacting the surface with a solution of a metal-containing agent (for example, palladium chloride) under conditions such that the metal-containing agent complexes with the surface heterocyclic groups. In a particularly preferred embodiment of the invention said coating contains pyridine functionality.

Preferably the step of the derivatization or reaction or quarternization or complexation of the nitrogen containing aromatic heterocyclic groups is performed with a solution containing a metal salt or metal salts. In one embodiment the metal salt is palladium chloride.

Preferably the metal salt or salts attached to or reacted with the nitrogen containing aromatic heterocyclic groups of the coating are catalytic or initiating species.

The surface can then be contacted with a further solution containing a transition metal salt(s) under such conditions that the metal salt(s) is deposited onto the surface and reduced to an elemental metal(s).

A further aspect of the invention provides a means for depositing elemental metals by an electroless process. The method comprises the complexation of a metal-containing agent (e.g. palladium chloride) with a nitrogen containing aromatic heterocycle functionalised coating by the method described above. Further preferably exposing said metal complexed coating to a transition metal salt solution (e.g. a copper sulphate or nickel sulphate containing solution) under conditions such that the complexed nitrogen containing aromatic heterocycle functionalised coating is used as a catalytic centre to reduce the transition metal salt to an elemental metal (e.g. metallic copper or nickel). Again, in particularly preferred embodiments of the invention said coating contains pyridine functionality and is prepared by plasma polymerisation of a monomer of formula (I) or (Ia).

Low average power continuous wave and pulsed plasma polymerization in accordance with the invention have been found to be an effective means for functionalizing solid substrates with nitrogen containing aromatic heterocyclic groups, especially pyridine groups. The resulting functionalised surfaces are amenable to conventional pyridine derivatization, quarternization, and complexation chemistries.

Pyridine functionalised surfaces produced in accordance with the invention were derivatized, quarternized or complexed with a variety of haloalkanes and metal salts (e.g. bromobutane, benzyl chloride, palladium chloride). The pyridine functionalised surfaces quarternized with haloalkanes were found to offer excellent bactericidal performance that could be regenerated by rinsing in water. The application of metal salts to pyridine functionalised surfaces produced in accordance with the invention enabled the construction of metal microarrays by a procedure shown diagrammatically in Scheme 1.

Once the nitrogen containing aromatic heterocycle functionalised coating has been applied to the substrate, the heterocyclic group (e.g. pyridine, pyrimidine) may be further quarternized as required. In particular, it may be reacted with a haloalkane such as bromobutane, or benzyl chloride, for example as shown in Scheme 2 and Scheme 3. The quarternization process may be effected in a solvent such as an organic solvent. Examples of such solvents include alcohols such as methanol, and propan-2-ol.

The quarternization may result in the generation of surface species bearing ionic charge. Examples of the products of said quaternization include, but are not restricted to, polycationic, polyanionic or polyzwitterionic containing coatings.

Thus in a further embodiment, the invention provides a method for the generation of a polycationic, polyanionic or polyzwitterionic thin films at a surface. Said method comprising the application of a reactive nitrogen containing aromatic heterocycle containing coating to a surface by a plasma method described above, and then contacting the surface with a solution of a haloalkane, or other suitable agent, under conditions such that the haloalkane agent reacts with the nitrogen containing aromatic heterocyclic groups to produce the desired ionic charge bearing surface. In a preferred embodiment of the method said reactive coating contains pyridine functionality and is prepared by plasma polymerisation of a monomer of formula (I) or (Ia).

The invention will now be particularly described by way of example with reference to the accompanying diagrammatic drawings and reaction schemes in which:

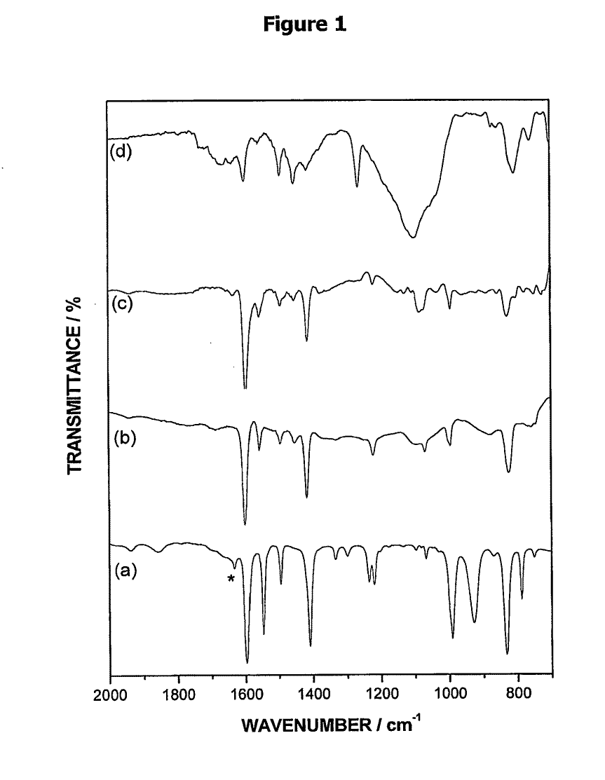

FIG. 1 shows the FTIR spectra of: (a) 4-vinyl pyridine monomer; (b) spin-coated poly(4-vinyl pyridine); (c) pulsed plasma deposited poly(4-vinyl pyridine); and (d) 10 W CW 4-vinyl pyridine plasma polymer. * denotes a polymerizable alkene bond.

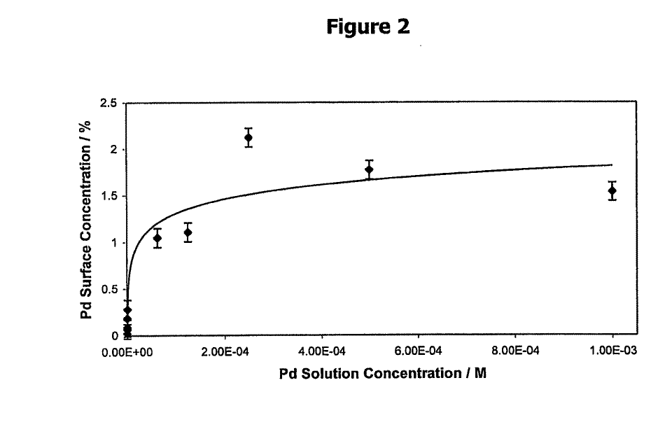

FIG. 2 shows a graph of the surface palladium concentration, as measured by XPS, as a function of the palladium solution concentration.

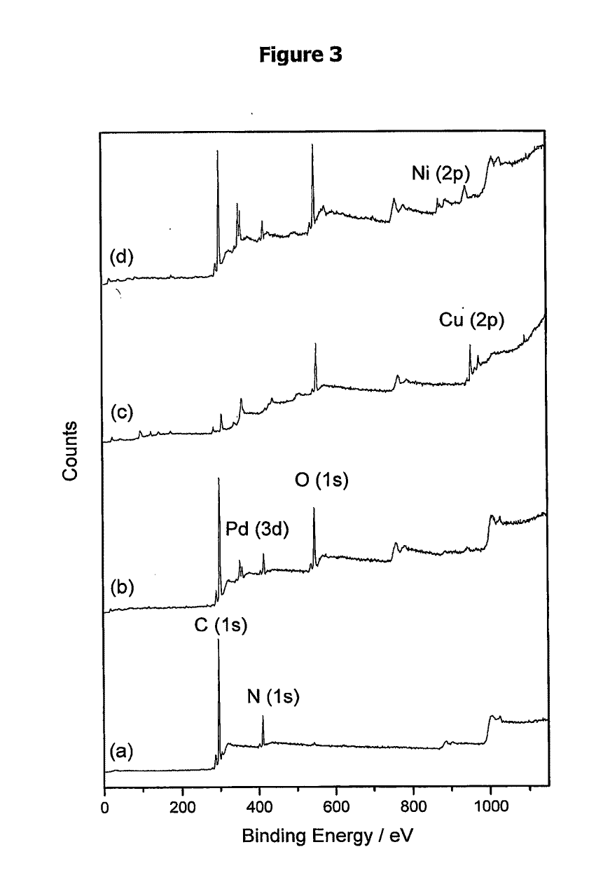

FIG. 3 shows XPS wide scans of (a) poly(4-vinyl pyridine) pulsed plasma polymer (pp4VP); (b) poly(4-vinyl pyridine) pulsed plasma polymer reacted with a palladium chloride solution (pp4VP-PdCl₂); (c) pp4VP-PdCl₂ films reacted in copper sulphate bath and (d) pp4VP-PdCl₂ films reacted in a Shipley EL468 nickel bath.

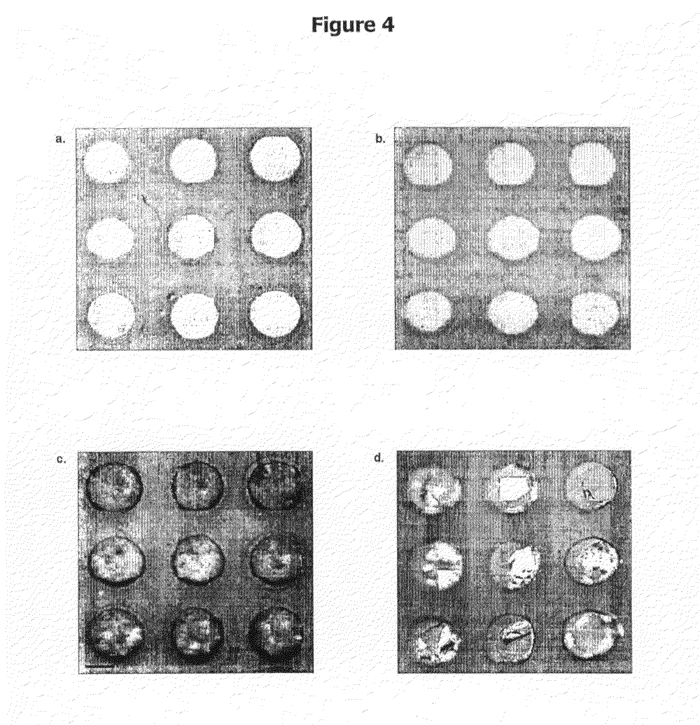

FIG. 4 shows optical images of arrays of (a) pulsed plasma poly(4-vinyl pyridine) deposited onto PTFE; (b) Pd functionalized (a); (c) Cu electrolessly deposited onto (b); and (d) Ni electrolessly deposited onto (b).

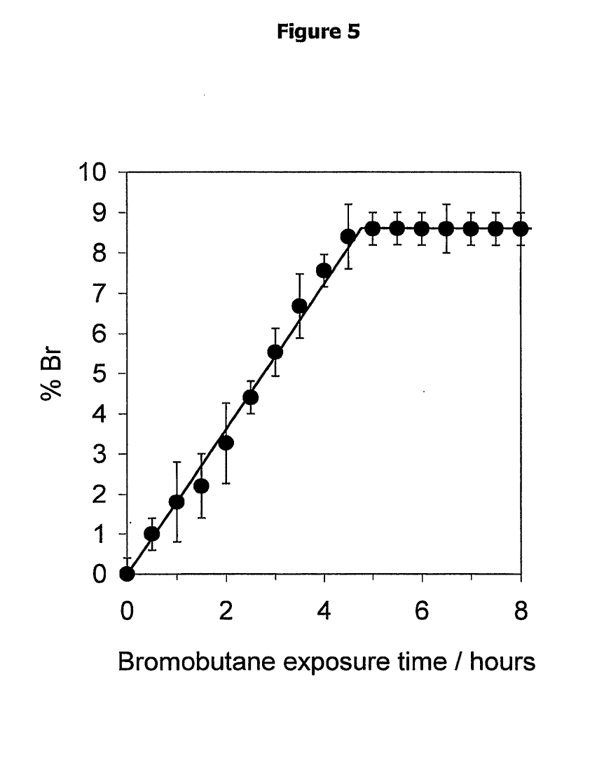

FIG. 5 shows a graph of the surface bromine concentration (measured by XPS) of a pulsed plasma poly(4-vinyl pyridine) polymer layer following immersion in bromobutane and rinsing, as a function of exposure time.

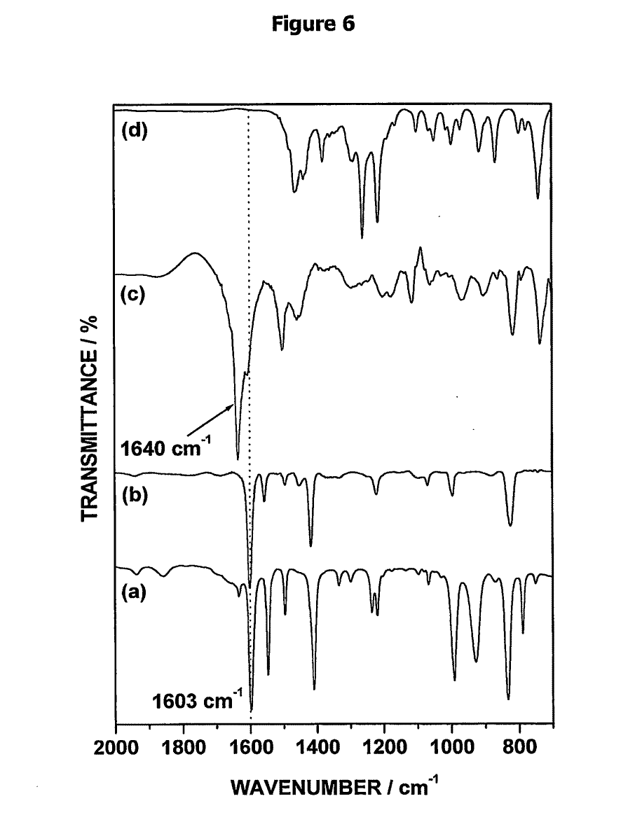

FIG. 6 shows the FTIR spectra of (a) 4-vinyl pyridine monomer; (b) poly(4-vinyl pyridine) pulsed plasma polymer; (c) poly(4-vinyl pyridine) pulsed plasma polymer quarternized with bromobutane; and (d) bromobutane.

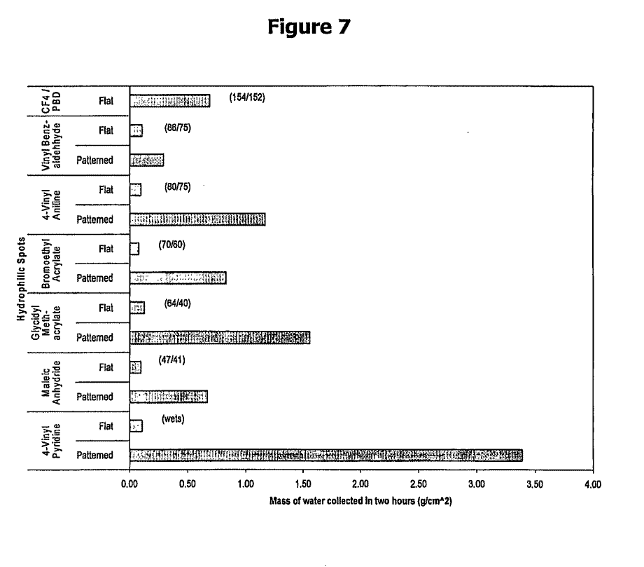

FIG. 7 shows the mass of condensed water collected after 2 hours from a range of hydrophilic plasma polymer coatings arrayed upon a super-hydrophobic background in 500 μm diameter spots spaced 1000 μm apart (centre-to-centre).

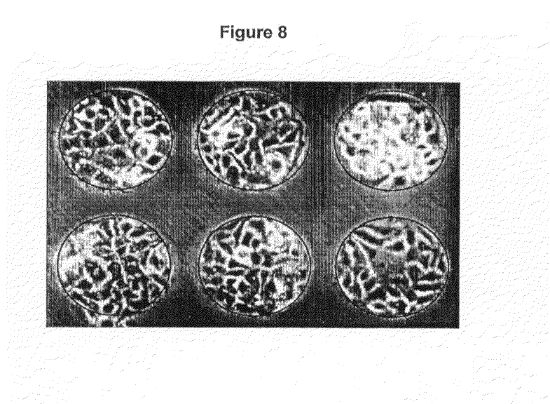

FIG. 8 shows MCF-7 cell growth after 24 hours on a pattern of 4-vinyl pyridine pulse plasma polymer spots on a background of protein resistant NASME pulse plasma polymer. The pattern was created by depositing the 4-vinyl pyridine through a grid held in close contact with the substrate, the grid dimensions were: diameter 100 microns, centre to centre 200 microns.

Scheme 1 shows a method of the invention for enabling patterned growth of metal onto pulsed plasma deposited poly(4-vinyl pyridine).

Scheme 2 shows a method of the invention for enabling the pulsed plasma deposition of pyridine functionalized solid surfaces and their subsequent quarternization with a haloalkane (bromobutane).

Scheme 3 shows a method of the invention for enabling the low-power continuous wave plasma deposition of pyridine functionalized solid surfaces and their subsequent quarternization with a haloalkane (bromobutane).

The following examples are intended to illustrate the present invention but are not intended to limit the same:

### EXAMPLE 1

Plasma polymerization of 4-vinyl pyridine (Aldrich, +97%, H₂C═CH(C₅H₄N), purified by several freeze-pump thaw cycles) was carried out in an electrodeless cylindrical glass reactor (5 cm diameter, 520 cm³ volume base pressure 3×10⁻² mbar, leak rate=1×10⁻⁹ mol s⁻¹) enclosed in a Faraday Cage. The chamber was fitted with a gas inlet, a thermocouple pressure gauge and a 30 L min⁻¹ two-stage rotary pump connected to a liquid nitrogen cold trap. All joints were grease free. An externally wound 4 mm diameter copper coil spanned 8-15 cm from the gas inlet with 9 turns.

The output impedance of a 13.56 MHz RF power supply was matched to the partially ionized gas load with an L-C matching network. In the case of pulsed plasma deposition, the RF source was triggered from an external signal generator, and the pulse shape monitored with a cathode ray oscilloscope. The reactor was cleaned by scrubbing with detergent, rinsing in water, propan-2-ol and drying in an oven. The reactor was further cleaned with a 0.2 mbar air plasma operating at 40 W for a period of 30 min. Each substrate was sonically cleaned in a 50:50 mixture of cyclohexane and propan-2-ol for 10 min and then placed into the centre of the reactor on a flat glass plate.

Infrared spectroscopy provided evidence for functional retention in the pulsed plasma polymer coating FIG. 1 and Table 1. For the 4-vinyl pyridine monomer, the following fingerprint band (2000-700 cm⁻¹) assignments can be made: vinyl C═C stretching (1634 cm⁻¹), aromatic quadrant C═C stretching (1597 cm⁻¹ and 1548 cm⁻¹), aromatic semicircle C═C and C═N stretching (1495 cm⁻¹ and 1409 cm⁻¹ respectively). Pulsed plasma poly (4-vinyl pyridine) gave rise to the same bands associated with the monomer, except that those bands associated with the vinyl C═C feature (1624 cm⁻¹) had undergone glow discharge initiate polymerization. In addition, a new band associated with CH₂ deformation (1453 cm⁻¹) was evident due to the growth of an aliphatic polymer backbone. The presence of intense aromatic ring stretching bands confirm minimal structural disruption to the desired pyridine functionality during pulsed plasma polymerization. fact, the IR spectra of a spin-coated film of a commercially available poly (4-vinyl pyridine) and pulsed plasma 4-vinyl pyridine are very similar. In marked contrast, it is evident that the continuous wave deposition of 4-vinyl pyridine caused a loss of structure.

TABLE 1
FTIR peak assignments for 4-vinyl pyridine (4-VP)
monomer and polymers prepared by solution phase,
continuous wave, and pulsed plasma deposition.

| | | Spin- | | Pulsed |
|---|---|---|---|---|
| | 4VP | Coated | Continuous | Plasma |
| Assignment | Monomer | P4VP | Wave 4VP | 4VP |
| Vinyl C═C stretching | 1634 | | | |
| Aromatic quadrant | 1597 | 1601 | 1601 | 1597 |
| C═C stretching | | | | |
| Aromatic quadrant | 1548 | 1557 | 1558 | 1556 |
| C═C stretching | | | | |
| Aromatic semicircle | 1495 | 1495 | 1494 | 1494 |
| C═C stretching | | | | |
| Polymer Backbone | | 1454 | 1453 | 1453 |
| CH₂ deformation | | | | |
| Aromatic semicircle | 1409 | 1418 | 1415 | 1414 |
| C═N stretching | | | | |
| C—C Skeletal | 1235 | | | |
| Stretching | | | | |
| C—C Skeletal | 1220 | 1221 | 1263 | 1221 |
| Stretching | | | | |
| Trans CH in | 991 | 994 | | 993 |
| phase wag | | | | |
| ═CH₂ Wag | 927 | | | |
| Adjacent H Wag | 832 | 824 | 808 | 828 |
| Adjacent H Wag | 789 | | 761 | 779 |

X-ray photoelectron spectroscopy (XPS) analysis of the deposited 4-vinyl pyridine plasma polymer layer confirmed the presence of only carbon and nitrogen at the surface, with no Si(2p) signal detected from the underlying silicon substrate, Table 2. Furthermore a good correlation was found to exist between the atomic percentages calculated for the monomer (theoretical) and the 4-vinyl pyridine pulsed plasma polymer film thereby indicating that the majority of the deposited polymer backbone comprised pyridine units.

TABLE 2
The surface atomic composition of 4-vinylpyridine
plasma polymers measured by XPS.

| | % C | % N | % O | % Br |
|---|---|---|---|---|
| Theoretical 4-VP | 87.5 ± 0.5 | 12.5 ± 0.5 | 0 | 0 |
| Pulsed Plasma | 87.0 ± 0.5 | 13.0 ± 0.5 | 0 | 0 |
| Polymer | | | | |
| 10 W CW Plasma | 87.9 ± 0.5 | 11.3 ± 0.5 | 0.8 ± 0.5 | 0 |
| Polymer | | | | |
| Pulsed Plasma | 85 ± 0.5 | 9.5 ± 0.5 | 0 | 5.5 ± 0.5 |
| Polymer + | | | | |
| bromobutane (3 h) | | | | |
| Pulsed Plasma | 84.5 ± 0.5 | 7.0 ± 0.5 | 0 | 8.5 ± 0.5 |
| Polymer + | | | | |
| bromobutane (6 h) | | | | |

### EXAMPLE 2

Pulsed plasma polymerised 4-vinyl pyridine, prepared as described in Example 1, was applied to non-woven polypropylene cloth (Corovin GmbH, MD300A, 125 um thickness). Water absorption measurements were adopted as a means for following the changes in wettability. This procedure entailed immersing individual polymer sheets in 1 ml of aqueous dye solution (0.625% wt solution of Coumarin 47 blue dye, Parker Pen Company). Any remaining excess liquid was then combined with water to make a 1 ml aliquot and analyses by UV-VIS absorption spectroscopy at 200 nm (this wavelength corresponds to dye absorption) using a spectrophotometer (UNICAM 4 UV4). Reference was then made to a set of calibration solutions.

The application of 4-vinyl pyridine pulsed plasma polymer to the non-woven PP cloth increased its absorptive capacity for water by a multiplication factor of ×50. Thus demonstrating the superhydrophilic properties of the pyridine containing surface coating, Table 3.

TABLE 3
Water Absorption Measurements as Measured by UV/VIS Analysis

| | Water Absorption/ |
|---|---|
| Sample | mg/mg of PP cloth |
| PP non-woven cloth | 0.05 |
| 4-VP pulsed plasma polymer treated PP | 2.50 |
| non-woven cloth | |

### EXAMPLE 3

Pulsed plasma polymerised 4-vinyl pyridine, prepared as described in Example 1, was applied to circular borosilicate glass discs (BDH, thickness No. 1, diameter 14 mm). The discs were subsequently autoclaved at 100° C. in a dry atmosphere. Epithelial Cells (designated MCF7) were quantitatively cultured in aqueous media containing Dulbeccos modified Eagle medium supplemented with Fetal Calf Serum (FCS) (Sigma 10%), Glutamine, Penicillin, Streptomycin (GPS) (5%, Sigma) at 37° C., in a controlled CO₂ environment (5% CO₂, 95% air). After 6 hours, the modified glass discs were removed from the serum and washed in 0.1 M PBS solution, 0.25% (w/v) Tripsin in 0.53 mM EDTA solution, and deionised water to remove serum and fix cells. This procedure was repeated using uncoated glass discs (“control” sample). The number of epithelial cells on coated and uncoated glass discs was measured by the viable cell-counting method.

The application of 4-vinyl pyridine pulsed plasma polymer to the borosilicate glass discs increased the epithelial cell adhesion capacity by a multiplication factor of ×10, thus demonstrating the cell-adhesion promoting properties of the pyridine containing surface coating, Table 4.

TABLE 4
Cell adhesion results for 4-VP plasma polymer coated glass discs

| | Number of epithelial |
|---|---|
| Sample | cells after 6 hours |
| Borosilicate glass disc | 10 |
| Pulsed 4-vinyl pyridine polymer | 102 |

### EXAMPLE 4

Polytetrafluoroethylene (PTFE) (Goodfellow, 0.25 mm thickness) coated with pulsed plasma polymerised 4-vinyl pyridine, as described in Example 1, was submersed in an aqueous solution containing palladium chloride (Aldrich, 99%), 3.0 M sodium chloride (Sigma, 99.9%) and 0.5 M sodium citrate dehydrate (Aldrich 99%) (pH adjusted to 4.5 with citric acid monohydrate (Aldrich, 99%)) for 12 hours, before being washed in deioinised water. A palladium chloride concentration of at least 1 mM was used to ensure that the surface was fully loaded with Pd²⁺ ions.

Electroless copper deposition was carried out in aqueous solutions consisting of 1.5% copper sulphate pentahydrate (Fluka, 98%), 7% potassium sodium tartrate (Aldrich, 98%), 1% sodium hydroxide (Fluka 98%) and 50% formaldehyde (Aldrich, 37% in water). The pulsed plasma 4-vinyl pyridine polymer film were immersed in the solutions for 60 minutes to allow deposition to occur.

Electroless nickel was carried out in a commercially available bath, (Shipley, EL468). This bath contained nickel sulphate, dimethylaminoborane and components to maintain a suitable pH. The pulsed plasma 4-vinyl pyridine polymer films were immersed in the bath for 30 minutes to allow deposition to occur.

Palladium cation complexation to the plasma polymer surface was found to depend upon solution concentration, FIG. 2. A maximum level of 1.5% (as determined by XPS from the Pd(3d) peaks at 388 and 344 eV) was reached following exposure to a 2.5 μM solution for 10 hours. The N(1s) binding energy also increased from 397 to 400 eV following co-ordination with the Pd Ions.

The deposition of copper or nickel onto palladium activated pulsed plasma 4-vinyl pyridine polymer film: following immersion in their respective electroless deposition baths was visible to the naked eye. XPS wide scan analysis of the deposited copper and nickel films confirmed the presence of peaks at binding energy values at 955 and 975 eV for copper Cu(2p) and nickel Ni(2p) peaks at 873 and 893 eV respectively, FIG. 3. Control experiments revealed no metallization at the surface, verifying the presence of the palladium catalyst as a necessary prerequisite for the electroless deposition of metals to occur.

### EXAMPLE 5

PTFE substrates were embossed with a brass grid comprising 500 μm holes with a centre-to-centre separation of 1 mm. These embossed PTFE substrates were then coated with pulsed plasma 4-vinyl pyridine polymer coating, as described in Example 1. The grid was subsequently removed and the substrates treated with successive metal salt solutions, as described in Example 4 and shown in Scheme 1.

The copper and nickel metal array structures formed on the PTFE substrates by this procedure were discernible with by optical microscopy, FIG. 4. The arrays were viewed with a multi-step optical microscope (Spectrum One, Perkin Elmer) fitted with a ×20 magnification lens, and a 5,000 μm image was obtained with a 100 μm step resolution.

### EXAMPLE 6

Bromobutane quarternization of pulsed plasma polymerised 4-vinyl pyridine (4-VP) surfaces, prepared a described in Example 1, entailed their immersion in a 10% (vol/vol) solution of bromobutane (Aldrich+99% in propan-2-ol (Aldrich, +99%). This reaction mixture was then refluxed at 70° C. for periods of up to hours to yield poly(4-vinyl pyridine) quarternized surfaces, Scheme 2. The final stage of preparation comprised successive rinses in methanol and distilled water prior to air drying.

XPS analysis of the 4-vinyl pyridine pulsed plasma polymer films following their immersion in the bromobutane quarternization solution denoted the appearance of a Br(3d_{s/2}) signal (Binding Energy: 68.8 eV corresponding to the presence of bromide counter-anions, Table 2. This indicated successful pyridine-ring quarternization and the formation of a polycationic surface coating, Scheme 1. This was accompanied by corresponding shift in the N(1s) peak from 399.8 eV (uncharged nitrogen centres) to 402.1 eV (positively charged). The extent of surface quarternization (% Br) was found to correlate to the period of immersion in the bromobutane solution until saturation was reached, FIG. 5. Complete quarternization (i.e. a approximately 1:1 ratio of N(1s):Br(3d_{s/2})) required exposure periods exceeding 5 hours.

Infrared spectroscopy was also used to monitor the 4-VP pulsed plasma polymer films upon their exposure to bromobutane solution, FIG. 6. The appearance of a sharp new band at 1640 cm⁻¹, attributed to the C=N semicircle stretch (usually 1414 cm⁻¹) experiencing an electromeric effect imposed by quarternization an thus shifting to higher frequency (1640 cm⁻¹), was indicative of pyridine ring quarternization.

### EXAMPLE 7

Polypropylene (PP) non-woven film (Corovin GmBH, 0.125 mm thickness) was coated with 4-vinyl pyridine pulsed plasma polymer as described in Example 1 and subsequently quarternized with bromobutane solution as described in Example 6 and Scheme 2.

The antimicrobial performance of the quaternized coatings against Staphylococcus aureus (Gram-positive) and Klebsiella pneumonia (Gram-negative) was monitored in accordance with ASTM EE2149-01 protocol, “Standard Test Method for Determining the Antimicrobial Activity of Immobilized Antimicrobial Agents under Dynamic Contact Conditions”. A predetermined volume of a 24 hour culture of the relevant organism (microbes used in 0.1 M aqueous PBS buffer pH 7.0) was applied to the functionalized PP non-woven cloth material for 24 hour. Next, the residue of the culture was swabbed off for re-suspension in solution, followed by plating out using appropriate agars (50 ml of a yeast/dextrose broth), and further incubation for 24 hours at 37° C. This procedure was repeated using uncoated non-woven PP cloth (“control” sample), and the number of colony-forming units on both cloths was measured by the viable cell-counting method. Surface antimicrobial activity of the treated cloths was determined by comparing results from the test sample to a simultaneously run control sample and expressing as a percentage reduction.

Antibacterial testing of the quarternized 4-vinyl pyridine plasma polymers, deposited onto PP non-woven cloth, demonstrated active neutralization of both Gram-positive and Gram-negative bacterial colonies, Table 5. The level of quarternization determined whether the resultant material could be formally designated as an effective antibacterial medium (minimum >90% active). Cloths that had been fully quarternized (≧6 hours bromobutane exposure) completely neutralized both forms of bacterial colonies their surface and could hence be described as possessing effective, actively antimicrobial properties. The ability to kill Staphylococcus aureus appears of especially utility as it is a leading cause of nosocomial infections (antibiotic-resistant strains of bacteria such as methicillin-resistant Staphylococcus aureus (MRSA)), and nuisance organisms such as those that produce ammonia from urine.

TABLE 5
The ability of bromobutane quarternized 4-vinyl pyridine
pulsed plasma polymer attached to polypropylene non-woven
cloth to kill various bacteria upon contact.

| | | Bromobutane | Percentage |
|---|---|---|---|
| | | exposure | Bacteria Killed |
| Bacterium | Gram Type | time (h) | after 24 h |
| Staphylococcus aureus | Positive | 3 | 83.9 |
| Staphylococcus aureus | Positive | 6 | >99.9 |
| Klebsiella pneumoniae | Negative | 3 | 86.5 |
| Klebsiella pneumoniae | Negative | 6 | >99.9 |

It has also been observed that the anti-bacterial properties demonstrated by substrates prepared using the method of the invention are fully regenerated by rinsing in water.

### EXAMPLE 8

The ability of low-power continuous wave plasmas to produce structurally well-retained, actively anti-microbial coatings was proven by coating polypropylene (PP) non-woven film (Corovin GmBH, 0.125 mm thickness) with a 4-vinyl pyridine low-power continuous-wave plasma polymer.

The plasma deposition procedure was as described in Example 1, except that the 4-vinyl pyridine monomer was continuously excited by a 2 W plasma. The quarternization of the coated polypropylene with bromobutane solution and the subsequent measurement of its antimicrobial performance against Staphylococcus aureus (Gram-positive) and Klebsiella pneumonia (Gram-negative) was accomplished by procedures described in Example 7 and Scheme 3.

Antibacterial testing of the quarternized low-power continuous-wave 4-vinyl pyridine plasma polymers, deposited onto PP non-woven cloth, demonstrated active neutralization of both Gram-positive and Gram-negative bacterial colonies, Table 6.

TABLE 6
The ability of bromobutane quarternized 4-vinyl pyridine
low-power continuous-wave plasma polymer attached to polypropylene
non-woven cloth to kill various bacteria upon contact.

| | | Bromobutane | Percentage |
|---|---|---|---|
| | | exposure | Bacteria Killed |
| Bacterium | Gram Type | time (h) | after 24 h |
| Staphylococcus aureus | Positive | 3 | 85.3 |
| Staphylococcus aureus | Positive | 6 | >99.9 |
| Klebsiella pneumoniae | Negative | 3 | 89.4 |
| Klebsiella pneumoniae | Negative | 6 | >99.9 |

As previously observed for the pulsed plasma polymer, Example 7, cloths that had been fully quarternized (≧6 hours bromobutane exposure) completely neutralized both forms of bacterial colonies their surface and could hence be described as possessing effective, actively antimicrobial properties.

### EXAMPLE 9

Patterned surfaces that exhibit separate domains of hydrophilic and hydrophobic character have a number of applications that involve the spatial control of surface wettability (e.g. micro-fluidics). The super-hydrophilic behaviour of the pyridine functionalised coatings prepared by the method of the invention makes them ideal candidates for employment in such systems. This suitability was demonstrated by the successful preparation of micro-condensers comprising regions of poly(4-vinyl pyridine) pulsed plasma polymer arrayed upon a proprietary super-hydrophobic coating.

Super-hydrophobic substrates were coated with a regular array of super-hydrophilic regions by performing 4-vinyl pyridine pulsed plasma polymerisation through the brass grid described in Example 5. The water-condensation behaviour of the resultant patterned surfaces was then assessed by measurement of the mass of liquid that condensed and subsequently ran-off the samples after 2 hours of exposure to a mist of high purity water (BS 3978, Grade 1). The mist was generated by a nebulizer supplied with nitrogen gas (BOC, 99.7%) at a flow-rate of 11 L/min.

The water-condensing efficacy of the poly(4-vinyl pyridine) plasma polymer was referenced to a range of hydrophilic plasma polymers by the preparation of equivalent micro-condenser arrays using pulsed plasma deposition through the same brass grid, onto the same super-hydrophobic substrate.

The use of a poly(4-vinyl pyridine) plasma polymer to generate the hydrophilic regions of the patterned arrays was found to result in superior micro-condensation behaviour. The mass of water collected from said surfaces was significantly greater than that of the equivalent 4-vinyl aniline, bromoethylacrylate, glycidyl methacrylate, maleic anhydride and vinyl benzaldehyde functionalised surfaces, FIG. 7. The method of the invention is hence demonstrably suited to the production of super-hydrophilic surfaces of genuine utility.

### EXAMPLE 10

Cell growth with respect to surface functionality was utilized for the study of cell-cell interactions. A microarray was prepared comprising cell-friendly plasma deposited poly(4-vinyl pyridine) 100 μm diameter spots surrounded by a protein background of plasma deposited poly(NASME).

MCF7 cells were purchased from ATCC (Manassas, Va.). The cells were routinely maintained in αMEM (BloWhittaker, Walkersville, Md.) supplemented with 10% fetal bovine serum (Gibco, Grand Island, N.Y.), 2 mM glutamine, penicillin (100 Units/mL), and streptomycin (100 mg/mL) in a humidified chamber at 37° C. in 5% CO₂/95% O₂. Cells were grown in T-25 flasks (Gibco) to confluence. Cells were trypsinized, washed with phosphate buffered saline (pH 7.4), re-suspended in αMEM. Plasma polymers were deposited onto 1 cm diameter circular glass discs (Agar Scientific) and autoclaved at 110° C. Samples were then seeded with 500 cells at a concentration of 1000 cells/ml. Samples were cultured 24 well plates in a humidified chamber at 37° C. in 5% CO₉₅% O₂. At the required time, the samples were removed, washed with phosphate buffered saline (pH 7.4), stained with Hemoxyclin (Aldrich) for 1 minute and washed with distilled water. Samples were mounted onto glass microscope slides, covered with glass cover slips and cell counts were performed using an inverted optical microscope.

FIG. 8 shows MCF-7 cell growth after 24 hours on a pattern of 4-vinyl pyridine pulse plasma polymer spots on a background of protein resistant NASME pulse plasma polymer. The pattern was created by depositing the 4-vinyl pyridine through a grid held in close contact with the substrate, the grid dimensions were: diameter 100 microns, centre to centre 200 microns. This demonstrates improved cell growth on the pyridine surface coating. Potential applications could include tissue engineering, and STEM cell growth.

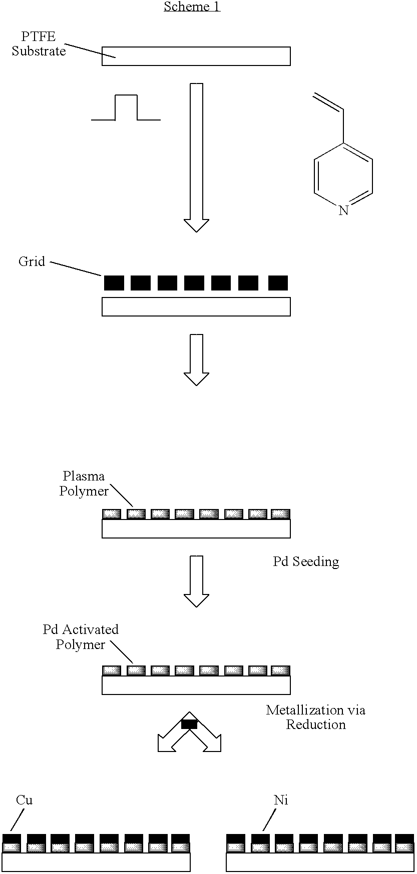

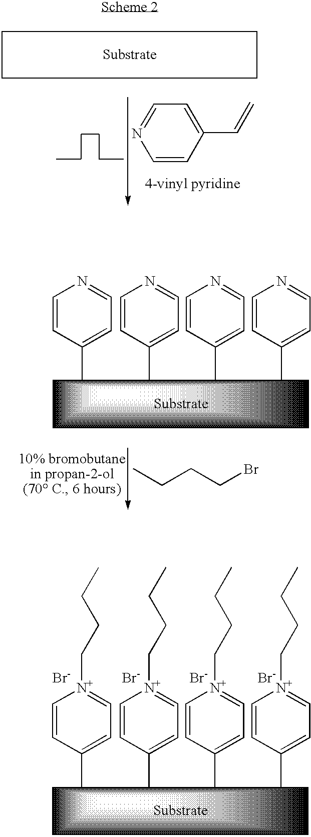

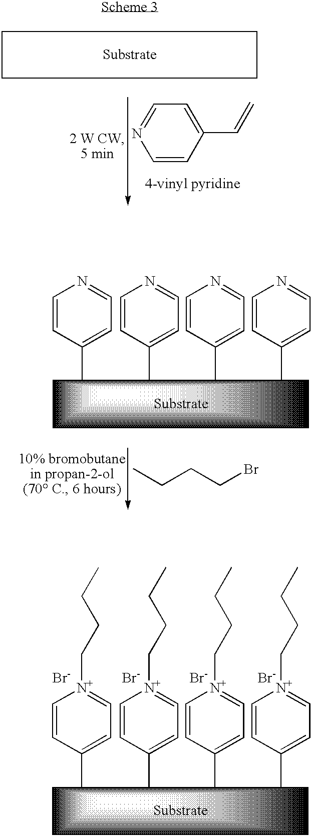

1. A method for applying a coating containing reactive nitrogen functionality contained within an aromatic heterocyclic structure to a substrate, said method including subjecting said substrate to a plasma discharge of a monomer possessing said heterocyclic nitrogen functionality.

2. A method according to claim 1 where said method includes subjecting the substrate to a plasma discharge in the presence of a compound that contains at least one conventionally polymerisable unsaturated functional group that is substantially distinct from the nitrogen containing aromatic ring structure desired at the substrate surface.

3. A method according to claim 2 wherein the at least one conventionally polymerisable unsaturated functional group is selected from acrylate, methacrylate, alkene, styrene, alkyne and/or derivatives thereof.

4. A method according to claim 2 wherein the nitrogen containing aromatic ring structure desired at the substrate surface is selected from the group of pyridine, pyrrole, quinoline, isoquiniline, purine, pyrimidine, indole and/or derivatives thereof.

5. A method according to claim 2 where said compound is a pyridine derivative of formula (I) or formula (Ia): 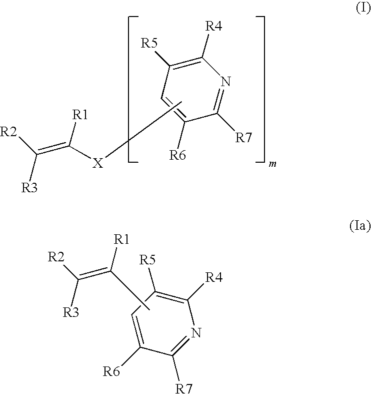
Where X is an optionally substituted straight or branched alkylene chain(s) or aryl group(s); R¹, R², R³, R⁴, R⁵, R⁶ or R⁷ are hydrogen or optionally substituted hydrocarbyl or heterocyclic groups; and m is an integer greater than 0.

6. A method according to claim 5 wherein the pyridine group, which itself may be optionally substituted, may be attached to the polymerisable moiety via ortho, meta or para substitution.

7. A method according to claim 5 wherein the pyridine containing organic compound of formula (Ia) is a compound of formula (Iai).

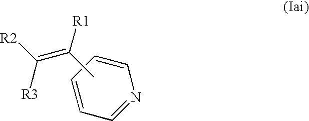

8. A method according to claim 7 wherein the pyridine containing organic compound of formula (Iai) is 4-vinyl pyridine.

9. A method according to claim 5 wherein the pyridine containing organic compound of formula (I) is a compound of formula (II) 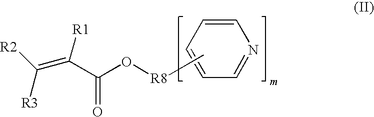
Where R⁸ is an optionally substituted hydrocarbyl or heterocyclic group and m is an integer greater than zero.

10. A method according to claim 9 wherein the compound of formula (II) is a compound of formula (III) 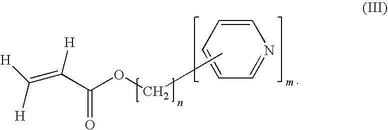
where n=1-20 and m is an integer greater than zero.

11. A method according to claim 10 wherein the compound of formula (III) is 4-ethyl acrylate pyridine.

12. A method according to claim 9 wherein the compound of formula (II) is a compound of formula (IIIa) 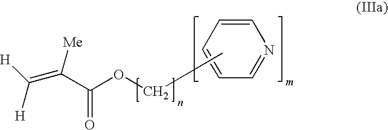
where n=1-20 and m is an integer greater than zero.

13. A method according to claim 12 wherein the compound of formula (IIIa) is 4-ethyl methacrylate pyridine.

14. A method according to claim 5 wherein the pyridine containing compound of formula (I) is a compound of formula (IV) 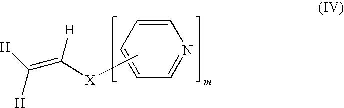
Where m is an integer greater than zero.

15. A method according to claim 14 wherein the compound of formula (IV) is a compound of formula (V) 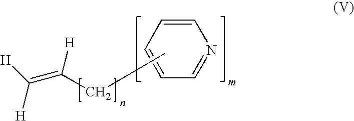
where n=1-20 and m is an integer greater than zero.

16. A method according to claim 15 wherein n=8.

17. A method according to claim 1 wherein the plasma is a low-power continuous-wave discharge.

18. A method according to claim 1 wherein the plasma discharge is pulsed.

19. A method according to claim 18 wherein the average power of the pulsed plasma discharge is less than 0.05 W/cm³.

20. A method according to claim 19 wherein the average power of the pulsed plasma discharge is less than 0.025 W/cm³.

21. A method according to claim 20 wherein the average power of the pulsed plasma discharge is less than 0.0025 W/cm³.

22. A method according to claim 18 wherein the pulsed plasma discharge is applied such that the power is on for from 10 μs to 100 μs, and off for from 1000 μs to 20000 μs.

23. A method according to claim 22 wherein the pulsed plasma discharge is applied such that the pulsing regime changes in a controlled manner throughout the course of a single coating deposition.

24. A method according to claim 1 wherein the plasma discharge contains said heterocyclic nitrogen containing monomer in the absence of any other material.

25. A method according to claim 1 wherein the additional materials to said heterocyclic nitrogen containing monomer are added to the plasma discharge.

26. A method according to claim 1 wherein the additional materials are inert and are not incorporated within the product coating.

27. A method according to claim 25 wherein the additional materials are non-inert and possess the capability to modify and/or be incorporated into the product coating.

28. A method according to claim 27 wherein the use of said non-inert additional materials results in a copolymer coating that contains reactive nitrogen functionality within an aromatic heterocyclic structure.

29. A method according to claim 1 wherein the introduction of the monomer and/or any additional materials into the plasma discharge is pulsed.

30. A method according to claim 1 wherein the introduction of the monomer and/or any additional materials into the plasma discharge is continuous.

31. A method according to claim 1 wherein the monomer and/or any additional materials are introduced into the plasma discharge in the form of atomised liquid droplets.

32. A method according to claim 1 wherein the means for applying the coating continuously is a reel-to-reel equipped plasma deposition apparatus.

33. A method according to claim 1 wherein the plasma deposition chamber is heated.

34. A method according to claim 1 which further includes the step of derivatization, or reaction, or quarternization, or complexation of the nitrogen-containing aromatic heterocyclic functionality after deposition of the coating.

35. A method according to claim 34 wherein the step of the derivatization or reaction or quarternization or complexation of the nitrogen functionality is performed with a haloalkane.

36. A method according to claim 35 wherein the haloalkane is bromobutane.

37. A method according to claim 27 wherein a solution of said haloalkane is contacted with the surface under conditions in which the haloalkane functionality reacts with the nitrogen functionality contained within the aromatic heterocyclic structures on the surface.

38. A method for the quarternization of an aromatic heterocyclic nitrogen functionalised reagent at a surface, said method including the application of a reactive heterocyclic nitrogen functionalised coating to said surface by a method according to any preceding claims, and then contacting the surface with a solution of said haloalkane-containing agent under conditions such that the haloalkane group reacts with the reactive nitrogen functionalities contained within the aromatic heterocyclic structures on the substrate surface.

39. A method according to claims 34 or 38 wherein said quarternized surfaces possess antibacterial properties.

40. A method according to claim 39 wherein the anti-bacterial properties of said quarternized surfaces are regenerated by washing in water or aqueous solution.

41. A method according to claim 34 wherein the step of the derivatization or reaction or quarternization or complexation of the nitrogen containing aromatic heterocyclic groups is performed with a solution containing a metal salt or metal salts.

42. A method according to claim 41 wherein the metal salt is palladium chloride (PdCl₂).

43. A method according to claim 41 wherein the metal salt or metal salts attached or reacted with the nitrogen containing aromatic heterocyclic groups of the coating are catalytic or initiating species.

44. A method according to claim 41 further including the step of contacting said surface with a further solution containing a transition metal salt(s) under such conditions that the metal salt(s) is deposited onto the surface and reduced to an elemental metal(s).

45. A method according to claim 44 wherein the transition metal salt is copper sulphate or nickel sulphate.

46. A method according to claim 44 wherein the further metal salt solution is spatially addressed onto the complexed reactive nitrogen containing surface, such that electroless deposition occurs only in given spatial locations.

47. A method according to claims 34 or 41 wherein the nitrogen-containing aromatic heterocyclic functionality is a pyridine derivative produced by plasma polymerisation of a monomer or monomers of formula (I) or (Ia).

48. A method according to claim 1 wherein the substrate is any of metal, glass, semiconductor, ceramic, polymer, woven or non-woven fibres, natural fibres, cellulosic material or powder.

49. A method according to claim 1 wherein the coated substrate is possessed of enhanced anti-microbial properties, bio-compatibility, cell-adhesion, super-hydrophilicity, or chemical reactivity by virtue of its coating.

50. A method according to claim 34 wherein the product of the derivatization, or reaction, or quarternization, or complexation of the nitrogen functionality is polycationic, polyanionic, or zwitterionic.

51. A method according to claim 1 wherein the coating is applied only to selected surface domains of the substrate to provide regions covered with nitrogen containing heterocyclic functionalised coating juxtaposed to regions exhibiting no nitrogen containing heterocyclic functionalised coating.

52. A substrate having a coating thereon, obtained by a process according to claim 1 or 38.
